(19) United States
(12) Patent Application Publication
(10) Pub. No.: US 2014/0186817 A1
(43) Pub. Date: Jul. 3, 2014

(54) RANKING AND RECOMMENDATION OF OPEN EDUCATION MATERIALS

(71) Applicant: FUJITSU LIMITED, Kawasaki-shi, Kanagawa (JP)

(72) Inventors: Jun WANG, San Jose, CA (US); Kanji UCHINO, San Jose, CA (US)

(73) Assignee: FUJITSU LIMITED, Kawasaki-shi (JP)

(21) Appl. No.: 13/731,996

(22) Filed: Dec. 31, 2012

(51) Int. Cl. G09B 7/00; G09B 3/00

(52) U.S. Cl. CPC G09B 7/00; G09B 3/00
USPC 434/362; 434/322

(57) ABSTRACT

A method of automatically ranking and recommending open education materials includes receiving a query. The method also includes calculating a content similarity measurement for each of multiple learning materials based on the query. The method also includes extracting multiple learning-specific features from the learning materials. The method also includes calculating one or more additional measurements for each of the learning materials based on the extracted learning-specific features. The one or more additional measurements are different than the content similarity measurement. The method also includes ranking each of the plurality of learning materials based on both the content similarity measurement and the one or more additional measurements.

### FIELD

The embodiments discussed herein are related to the ranking and recommendation of open education materials.

### BACKGROUND

Open education generally refers to online learning programs or courses that are made publicly available on the Internet or other public access networks. Examples of open education programs may include e-learning programs, Open Courseware (OCW), Massive Open Online Courses (MOOC), and the like. Various universities and other educational institutions offer open education programs free of charge to the general public without imposing any academic admission requirements. Participation in an open education program typically allows a user to access learning materials relating to any of a variety of topics. The learning materials may include lecture notes and/or video recordings of lectures by an instructor at the educational institution. Open education learning materials are also often available on or through the home pages of professors and other instructors at many educational institutions.

Various open education programs are currently offered by a number of educational institutions, including, among others, MIT, Yale, the University of Michigan, the University of California Berkeley, and Stanford, and the number of educational institutions offering open education programs has increased substantially since the inception of open education a little over a decade ago. With the proliferation of open education programs, there has been a concomitant increase in the number of available learning materials. However, in some cases, the large quantity of available learning materials may overwhelm users and make it difficult to identify learning materials that may be the most helpful or useful to users.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of automatically ranking and recommending open education materials includes receiving a query. The method also includes calculating a content similarity measurement for each of multiple learning materials based on the query. The method also includes extracting multiple learning-specific features from the learning materials. The method also includes calculating one or more additional measurements for each of the learning materials based on the extracted learning-specific features. The one or more additional measurements are different than the content similarity measurement. The method also includes ranking each of the plurality of learning materials based on both the content similarity measurement and the one or more additional measurements.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments may be implemented;

FIG. 2A shows an example flow diagram of a method that may be implemented in the operating environment of FIG. 1;

FIG. 2B includes a screen shot of an example search page that may be implemented in the operating environment of FIG. 1;

FIG. 3 is a block diagram of an example embodiment of a system that may be included in the operating environment of FIG. 1;

FIG. 4 includes screen shots of web pages that include and/or point to learning materials;

FIG. 5 includes screen shots of web pages that include or point to learning materials in the form of video;

FIG. 6 includes screen shots of web pages associated with an individual; and

FIG. 7 shows an example flow diagram of a method of automatically ranking and recommending open education materials.

### DESCRIPTION OF EMBODIMENTS

There has been little research on effective ranking and recommendation of open education learning materials. Many ranking mechanisms only use keyword matching, text similarity comparison, and simple condition filtering. Additionally, such ranking mechanisms may generally only be applied to learning materials in closed learning management systems instead of to learning materials available online in open education programs.

In contrast, some embodiments disclosed herein may provide an effective approach for ranking and recommendation of online open education learning materials. In general, example embodiments may rank and recommend learning materials based on a content similarity measurement, a user profile match, and/or learning-specific feature extraction and one or more additional measurements related to the extracted learning-specific features. The additional measurements may include, but are not limited to, a freshness measurement, an academic credit measurement, a social media credit measurement, and a comprehensiveness measurement, as described in more detail below.

In an example embodiment, a query is received from a user. The query may include one or more keywords and/or a request to identify learning materials that are related to particular learning material. The query may be represented as a term vector in a vector space model. Learning materials may also be represented by term vectors such that a content similarity measurement may be calculated for each of the learning materials based on the query. Optionally, the calculation of the content similarity measurement may additionally be based on the user profile by, e.g., boosting a weight of terms in the learning material term vectors that match terms in a user profile vector representing the user profile.

Learning-specific features may be extracted from each learning material, such as an associated individual (e.g., a professor, instructor, or author of the learning material), a title, a teaching or publication date, an associated course, an associated educational institution, content of the learning material, and/or other learning-specific features as described herein. The additional measurements may be calculated based on the extracted learning-specific features, and the learning materials may be ranked based on both the content similarity measurement and the additional measurements.

The ranking and recommendation of learning materials as described herein may be applied to rank and/or recommend learning materials in open education systems and/or in closed learning management systems. For example, the ranking and recommendation of learning materials as described herein may be applied in learning material search systems, in open learning material repositories or topic catalogues to identify related learning material and/or to make recommendations of related learning material, and/or to support specific open education-related projects, such as the Guided Learning Pathway (GLP) project at MIT. As another example, the ranking and recommendation of learning materials may be applied in university learning management systems requiring user authentication and/or in other closed learning management systems to rank and recommend learning materials, whether open education learning materials or closed learning management learning materials.

Embodiments of the present invention will be explained with reference to the accompanying drawings.

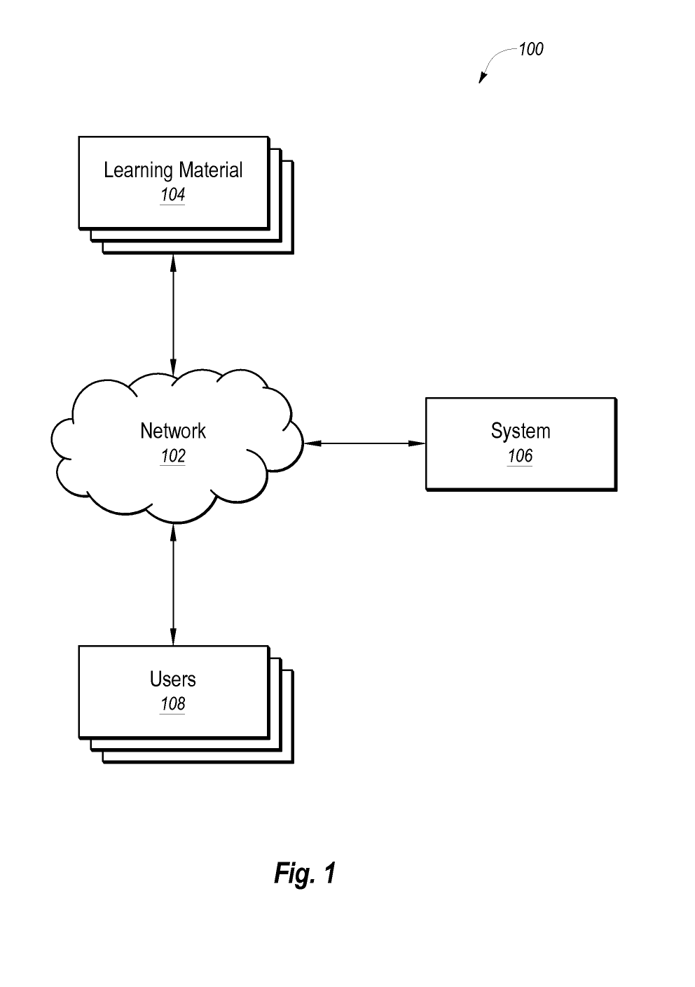

FIG. 1 is a block diagram of an example operating environment 100 in which some embodiments may be implemented. The operating environment 100 may include a network 102, learning materials 104, a ranking and recommendation system (hereinafter “system”) 106, and one or more end users (hereinafter “users”) 108.

In general, the network 102 may include one or more wide area networks (WANs) and/or local area networks (LANs) that enable the system 106, and/or the users 108 to access the learning materials 104 and/or to communicate with each other. In some embodiments, the network 102 includes the Internet, including a global internetwork formed by logical and physical connections between multiple WANs and/or LANs. Alternately or additionally, the network 102 may include one or more cellular RF networks and/or one or more wired and/or wireless networks such as, but not limited to, 802.xx networks, Bluetooth access points, wireless access points, IP-based networks, or the like. The network 102 may also include servers that enable one type of network to interface with another type of network.

The learning materials 104 may include any of a variety of online resources such as open courseware (OCW) learning materials, massive open online courses (MOOC) learning materials, course pages for courses taught at educational institutions by individuals including professors and lecturers, lecture notes and/or recordings (e.g., video and/or audio recordings) associated with such courses, online publications including journal articles and/or conference papers, or the like or any combination thereof. The learning materials 104 may be accessible on websites hosted by one or more corresponding web servers communicatively coupled to the Internet.

The users 108 include people and/or other entities that desire to find learning materials that satisfy or match a particular query. Example queries may include one or more keyword or search terms and/or a request to identify learning materials that are related to particular learning material. Although not separately illustrated, each of the users 108 typically communicates with the network 102 using a corresponding computing device. Each of the computing devices may include, but is not limited to, a desktop computer, a laptop computer, a tablet computer, a mobile phone, a smartphone, a personal digital assistant (PDA), or other suitable computing device.

In general, the system 106 may be configured to rank and recommend learning materials 104 to the users 108 based on queries received from the users 108. To this end, the system 106 may receive queries from the users 108. For a given query, the system 106 may calculate a content similarity measurement for each of the learning materials 104 based on the query. In some examples, the content similarity measurement is further based on a user profile of the corresponding user 108. For instance, if the user profile indicates one or more topics of interest to the user 108, a weight of terms in a vector of a corresponding learning material 104 that match any of the topics of interest to the user 108 may be boosted in the content similarity measurement for that learning material 104.

The system 106 may additionally extract learning-specific features from the learning materials 104. As used herein, “learning-specific features” may include features such as metadata that are specific to and/or describe a corresponding one of the learning materials 104. The system 106 may calculate one or more additional measurements for each of the learning materials 104 based on the extracted learning-specific features. The additional measurements may be different than the content similarity measurement. The additional measurements may include, but are not limited, a freshness measurement, an academic credit measurement, a social media credit measurement, and a comprehensiveness measurement. More generally, the one or more additional measurements may be referred to as a first measurement, a second measurement, and so on. The system 106 may additionally rank each of the learning materials 104 based on both the content similarity measurement and the additional measurements.

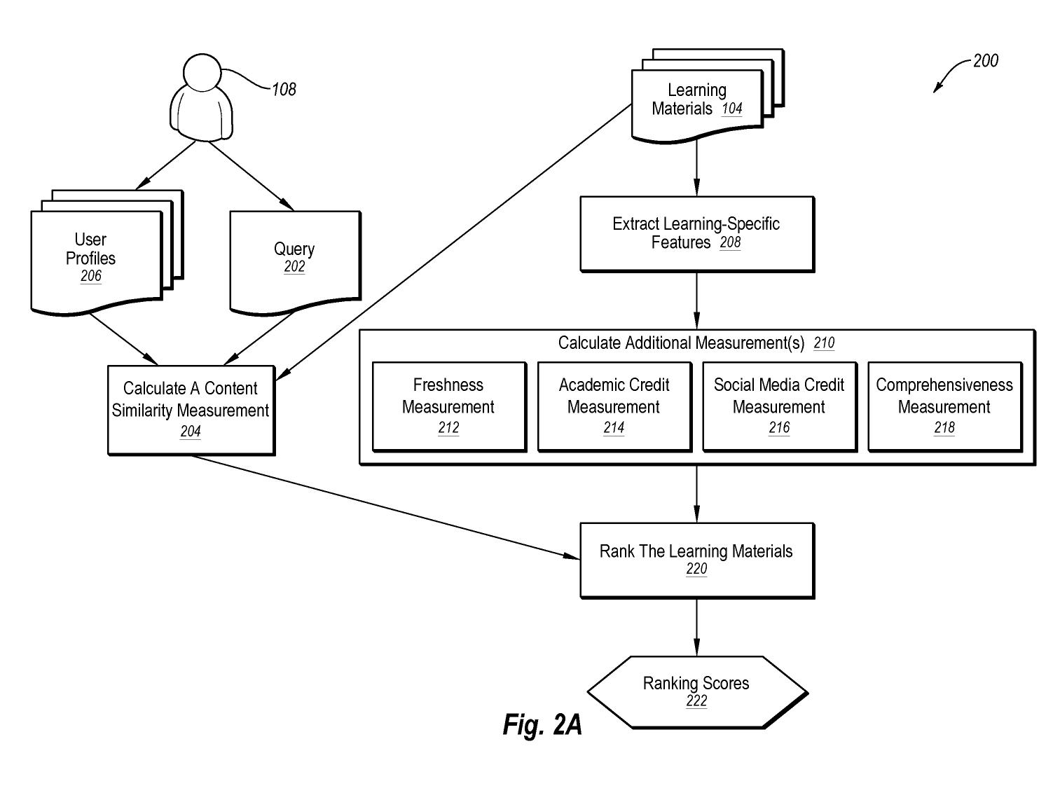

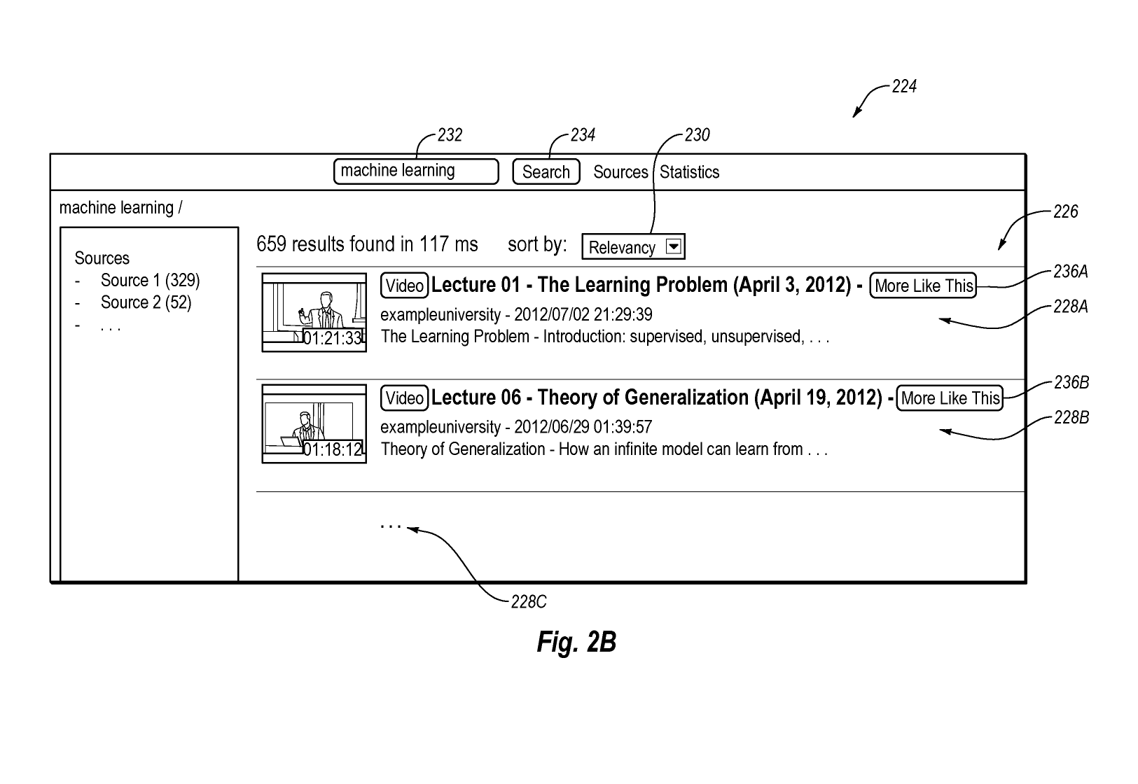

FIG. 2A shows an example flow diagram of a method 200 that may be implemented in the operating environment 100 of FIG. 1, arranged in accordance with at least one embodiment described herein. The method 200 in some embodiments is performed by the system 106 of FIG. 1. Although illustrated as discrete blocks, various blocks may be divided into additional blocks, combined into fewer blocks, or eliminated, depending on the desired implementation. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

With combined reference to FIGS. 1-2A, the method 200 may include receiving a query 202 from one of the users 108. At block 204, a content similarity measurement for each of the learning materials 104 may be calculated based on the query 202. Optionally, the calculation of the content similarity measurement may be further based on a user profile 206 of the user 108. At block 208, learning-specific features may be extracted from the learning materials 104. At block 210, one or more additional measurements 212, 214, 216, 218 may be calculated for the learning materials 104 based on the extracted learning-specific features. In the illustrated embodiment, the additional measurements 212, 214, 216, 218 include a freshness measurement 212, an academic credit measurement 214, a social media credit measurement 216, and a comprehensiveness measurement 218; however, the illustrated additional measurements 212, 214, 216, 218 are not meant to be limiting. At block 220, the learning materials 104 are ranked based on the content similarity measurement and the one or more additional measurements to generate a ranking score 222 for each of the learning materials.

The ranking scores 222 may be output to the user 108. Alternately or additionally, links to the learning materials 104 and/or short descriptions thereof may be output to the user 108 with an order of the links reflecting the ranking scores 222, or the relevancy, of each of the learning materials 104 with respect to the query 202. For example, FIG. 2B includes a screen shot of an example search page 224 that may be implemented in the operating environment 100 of FIG. 1, arranged in accordance with at least one embodiment described herein. With combined reference to FIGS. 1-2B, the search page 224 may be accessed by the user 108 via the network 102 to submit queries 202 to the system 106 and to receive query results 226. The search page 224 may be hosted by the system 106 or an associated web server, for example.

In the illustrated embodiment, the query results 226 include learning material blocks 228A-228B (collectively “learning material blocks 228”) that each includes links to corresponding learning materials 104 and short descriptions thereof. Ellipses 228C indicate that there may be more such learning material blocks 228 in the query results 226. More generally, the inclusion of ellipses, such as the ellipses 228C of FIG. 2B, in any of the Figures indicates that additional list items, content, information, or the like may be included in place of the ellipses and the ellipses have merely been provided to simplify the Figures. The learning material blocks 228 may be sorted in the query results 226 according to corresponding ranking scores 222, as indicated by the term “Relevancy” or equivalent term in the “sort by” drop-down menu 230. The drop-down menu 230 may additionally include other “sort by” options.

The search page 224 additionally includes a search field 232 where the user 108 may input a query 202 including one or more keyword search terms, such as “machine learning” in the illustrated embodiment. The user 108 may submit the query 202 by selecting a button 234 or providing other suitable input.

Alternately or additionally, one or more of the learning material blocks 228 in the query results 226 may include a recommendation button 236A, 236B (collectively “recommendation buttons 236”) that, when selected, submits a query to the system 106 in the form of a request to identify learning materials 104 that are similar or otherwise related to the learning material 104 pointed to by the corresponding link in the corresponding learning material block 228A or 228B. In response, the system 106 may return query results with learning material blocks including links to learning materials 104 that are similar to the learning material 104 associated with the corresponding learning material block 228. In some embodiments, selection of a recommendation button 236 may generate a query that includes a title or one or more keywords of the learning material 104 associated with the corresponding learning material block 228. Thus, selection of any of the recommendation buttons 236 by the user 108 may generate and submit a new query 202 that may then be processed as generally already described with respect to FIG. 2A.

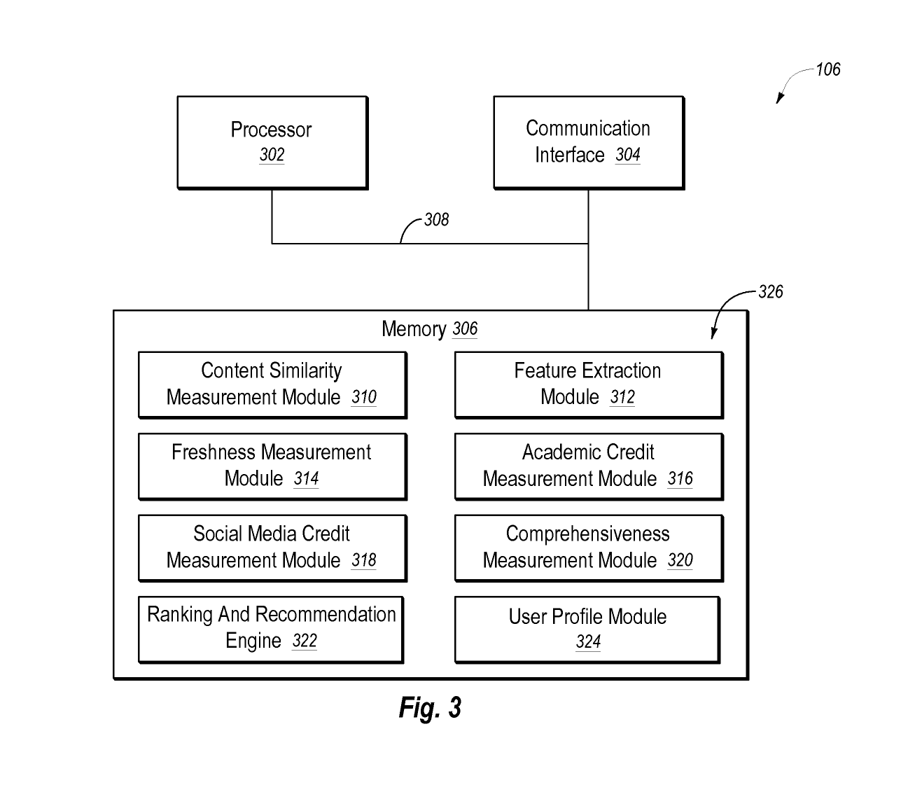

FIG. 3 is a block diagram of an example embodiment of the system 106 of FIG. 1, arranged in accordance with at least one embodiment described herein. As illustrated, the system 106 includes a processor 302, a communication interface 304, and a memory 306. The processor 302, the communication interface 304, and the memory 306 may be communicatively coupled via a communication bus 308. The communication bus 308 may include, but is not limited to, a memory bus, a storage interface bus, a bus/interface controller, an interface bus, or the like or any combination thereof.

In general, the communication interface 304 may facilitate communications over a network, such as the network 102 of FIG. 1. The communication interface 304 may include, but is not limited to, a network interface card, a network adapter, a LAN adapter, or other suitable communication interface.

The processor 302 may be configured to execute computer instructions that cause the system 106 to perform the functions and operations described herein, such as receiving a query, calculating a content similarity measurement for each of multiple learning materials based on the query, extracting learning-specific features from the learning materials, calculating one or more additional measurements for each of the learning materials based on the extracted learning-specific features, and ranking each of the learning materials based on both the content similarity measurement and the one or more additional measurements. The processor 302 may include, but is not limited to, a processor, a microprocessor (μP), a controller, a microcontroller (X), a central processing unit (CPU), a digital signal processor (DSP), any combination thereof, or other suitable processor.

Computer instructions may be loaded into the memory 306 for execution by the processor 302. For example, the computer instructions may be in the form of one or more modules, such as, but not limited to, a content similarity measurement module 310, a feature extraction module 312, a freshness measurement module 314, an academic credit measurement module 316, a social media credit measurement module 318, a comprehensiveness measurement module 320, a ranking and recommendation engine 322, and/or a user profile module 324 (collectively “modules 326”). In some embodiments, data generated, received, and/or operated on during performance of the functions and operations may be at least temporarily stored in the memory 306. Moreover, the memory 306 may include volatile storage such as random access memory (RAM). More generally, the system 106 may include a tangible computer-readable storage medium such as, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible computer-readable storage medium.

The content similarity measurement module 310 may be configured to calculate a content similarity measurement for each of multiple learning materials based on a query received from a user. The calculation of the content similarity measurement may additionally be based on a user profile associated with a user from which the query is received.

In these and other embodiments, the query and each of the learning materials may be represented as a term vector in a vector space model. For each of the learning materials, the content similarity measurement, CSM, may be calculated according to the following formula:

CSM=Similarity(q,d)=cos(θ), 0<cos(θ)<1,

where q is the term vector of the query, d is the term vector of the corresponding learning material, and cos(θ) is the cosine of the angle θ between the term vectors q and d. As previously mentioned, when the content similarity measurement is additionally based on the user profile, a weight of terms in the term vector d that match keywords in the user profile, such as topics of interest in the user profile, may be boosted in the content similarity measurement for the corresponding learning material.

The feature extraction module 312 may be configured to fetch learning materials and extract learning-specific features from the learning materials. In some embodiments, the learning-specific feature extraction is performed in a manner identical or substantially similar to the feature extraction disclosed in co-pending United States patent application Ser. No. ______, entitled SPECIFIC ONLINE RESOURCE IDENTIFICATION AND EXTRACTION and filed concurrently herewith. The foregoing application is herein incorporated by reference.

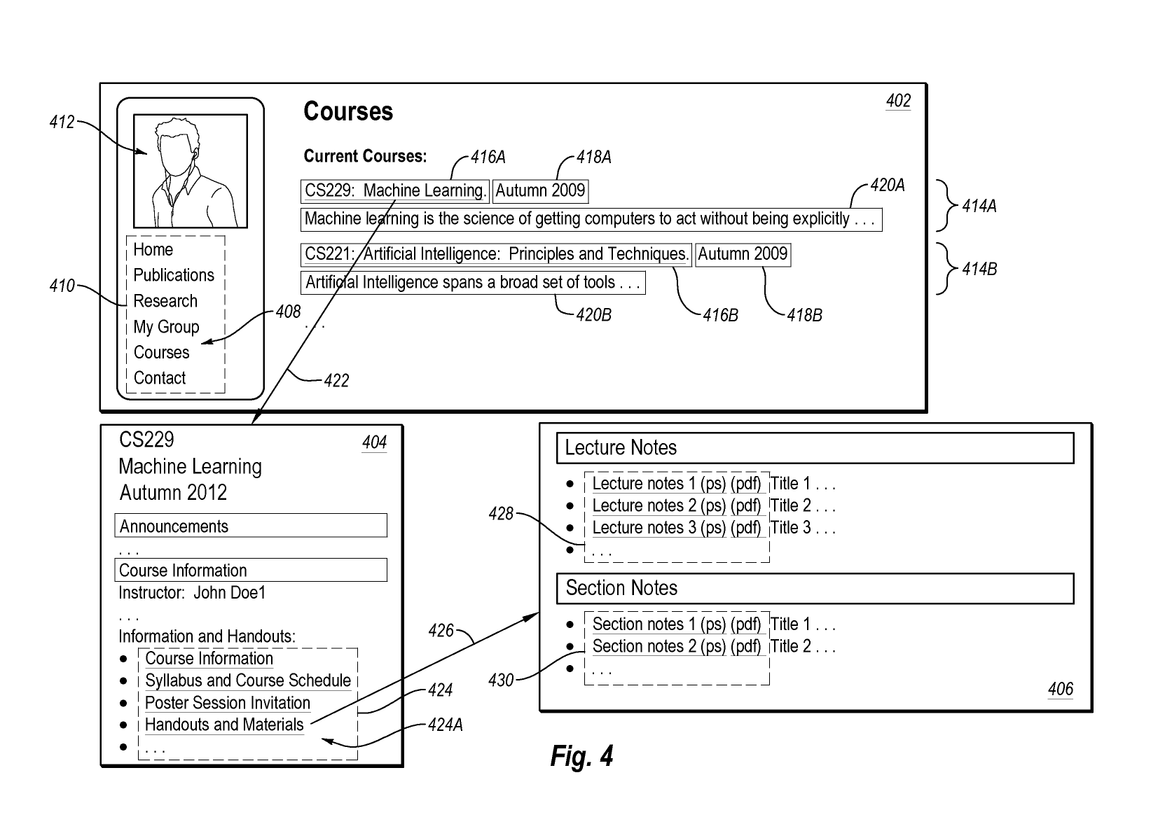

A general overview of learning-specific feature extraction according to an example embodiment will now be described with respect to FIG. 4. FIG. 4 includes screen shots of web pages 402, 404, 406 that include and/or point to learning materials, arranged in accordance with at least one embodiment described herein. With combined reference to FIGS. 1, 3, and 4, the feature extraction module 312 may fetch a course web page 402 via a link 408 included in a navigation menu 410 of a home page of a professor 412. The courses web page 402 may include one or more course information blocks 414A, 414B, each corresponding to a different course taught by the professor 412. The feature extraction module 312 may analyze the courses web page 402 to extract learning-specific features therefrom, such as a title 416A, 416B of the corresponding course, a time period 418A, 418B when the corresponding course is or was taught, a description 420A, 420B of the corresponding course and/or its subject matter, or the like or any combination thereof.

The analysis of the courses web page 402 by the feature extraction module 312 may identify links such as anchor text and/or uniform resource locators (URLs) pointing to course-specific web pages. In particular, the feature extraction module 312 may discover that each of the titles 416A, 416B or other text of the course information blocks 414A, 414B is an anchor text pointing to a corresponding course-specific web page. For instance, the title 416A is an anchor text pointing to a course-specific web page 404, as indicated by arrow 422. The course-specific web page 404 includes information regarding the corresponding course that may be extracted instead of or in addition to the information extracted from the courses web page 402, such as the course title, time period when the course is or was taught, a name of the professor 412 or other course instructors, or the like or any combination thereof.

The course-specific web page 404 additionally includes various links 424 in the form of anchor texts that point to additional web pages that may be further analyzed to extract learning-specific features. For example, the links 424 include a link 424A pointing to a learning materials page 406, as indicated by arrow 426.

The learning materials page 406 includes links 428, 430 to specific learning materials that may correspond to the learning materials 104 of FIG. 1. The feature extraction module 312 may extract learning-specific features from the learning materials page 406. Alternately or additionally, the feature extraction module 312 may fetch each of the learning materials pointed to by the links 428, 430 and may extract learning-specific features therefrom.

Accordingly, the fetching and analysis of the various web pages 402, 404, 406 and/or the corresponding learning materials by the feature extraction module 312 may yield, for each of the learning materials, various learning-specific features. Examples of learning-specific features for each of the learning materials may include, but are not limited to, a course title and/or course number of a course in which the learning material is used, a course syllabus or content of the course, a time period when the course is or was taught, a description of the course, a professor or other instructor of the course, an educational institution at which the course is taught, a title of the learning material, content of the learning material, and the like or any combination thereof.

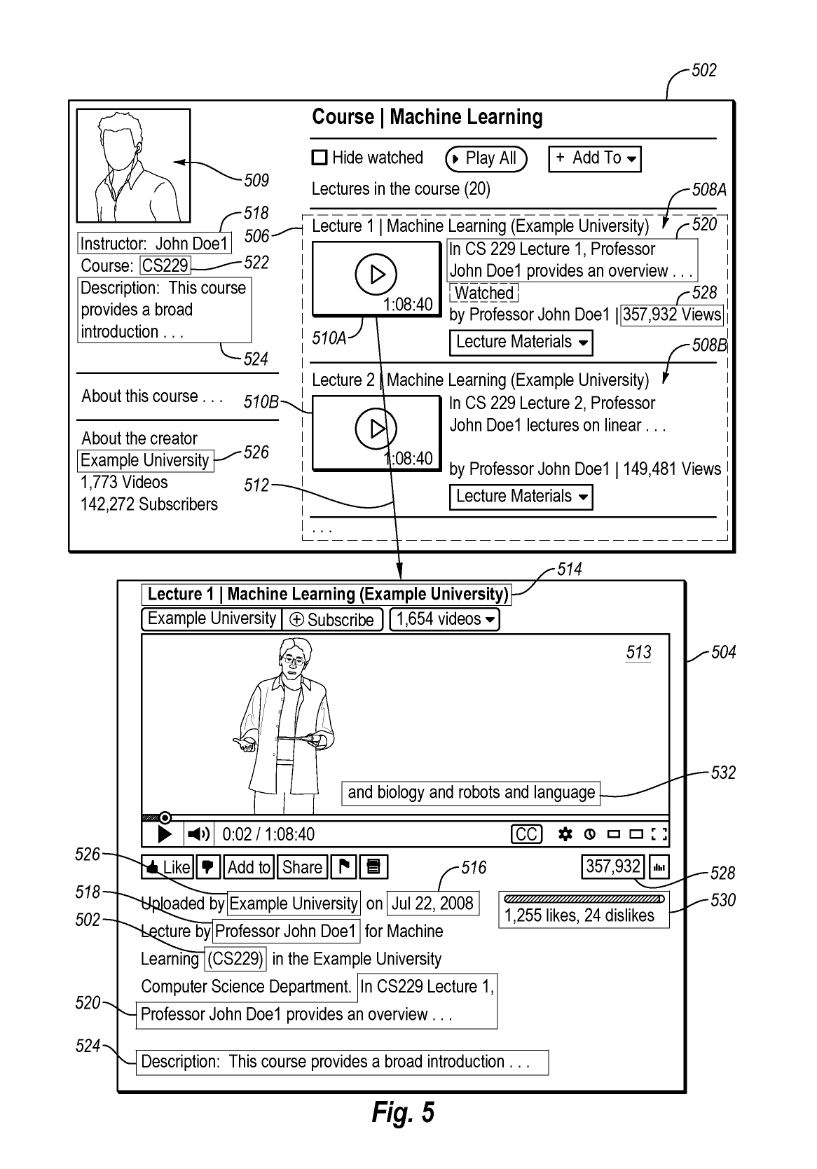

Another example of learning-specific feature extraction will now be described with reference to FIG. 5, which includes screen shots of web pages 502, 504 that include and/or point to learning materials in the form of video, arranged in accordance with at least one embodiment described herein. With combined reference to FIGS. 1, 3, and 5, the feature extraction module 312 may fetch a video list web page 502 including a listing 506 of one or more video lecture blocks 508A, 508B, each corresponding to a different video lecture of a professor 509. Each of the video lecture blocks 508A, 508B may include a link 510A, 510B to a corresponding video web page in which the corresponding video lecture may be played. For example, the link 510A in the video lecture block 508A may point to a video web page 504, as denoted by arrow 512, in which a video 513 pointed to by the link 510A in the first video lecture block 508A may be played and viewed by users 108.

In general, the feature extraction module 312 may be configured to fetch web pages such as the video list web page 502 and/or the video web page 504 to extract learning-specific features. For each learning material in the form of a video, such as the video 513, the learning-specific features that are extracted from the video list web page 502 and/or the video web page 504 may include, but are not limited to, a video title 514, a date 516 on which the video 513 was published or otherwise made available online, a professor or other individual 518 giving the lecture recorded in the video 513, a description 520 of the content of the video 513, a course title and/or course number 522 for which the lecture recorded in the video 513 was given, a description 524 of the course, an educational institution 526 at which the course is taught, a user access value 528 indicating a number of viewers of the video 513, rating information 530, subtitles 532 of the video 513, or the like or any combination thereof.

Returning to FIG. 3, the freshness measurement module 314 may be configured to calculate a freshness measurement for each learning material 104 based on the extracted learning-specific features. In these and other embodiments, some users 108 may have a preference for the latest learning materials. For example, if a professor teaches the same course multiple years, the most recent course learning materials may be preferred by the users 108 over older course learning materials since the professor may update the course learning materials from one year to the next.

For each learning material 104, the freshness measurement, FM, may be calculated according to the following formula:

FM=e^{(TY-CY/M)},

where TY is a teaching date or publication date of the learning material 104, CY is a current date, and M is a constant that may be used to adjust freshness impact and is selected such that 0<FM<1. The dates TY and CY may each include a year, a semester, a month, a day of the month, or the like or any combination thereof.

The academic credit measurement module 316 may be configured to calculate an academic credit measurement for each learning material 104 based on the extracted learning-specific features. In some embodiments, the academic credit measurement depends on both a productivity of an individual associated with the learning material 104 and a match between the learning material 104 and published works of the individual. In some embodiments, the individual associated with the learning material 104 may be an author or coauthor of the learning material 104.

A productivity measurement may be used to quantify the productivity of the individual for use in calculating the academic credit measurement of the learning material. Examples of productivity measurements include, but are not limited to, an H-index or a G-index of the individual, or the like or any combination thereof. The H-index is also sometimes referred to as the Hirsch index or Hirsch number. Productivity measurements for individuals may be obtained from any of a variety of sources, such as academic research websites, including http://academic.research.microsoft.

In some embodiments, and for each learning material 104, the academic credit measurement, ACM, may be calculated according to the following formula:

ACM=Log(P(pLM)+Init)*Σᵢ₌₁ⁿSimilarity(LM,PWi)/n,

where LM is the learning material 104, pLM is the individual associated with the learning material, P(pLM) is a productivity measurement of the individual—such as the H-index or the G-index of the individual, n is a total number of the published works of the individual, PWi—with i ranging from 1 to n—is all published works of the individual such that Σᵢ₌₁ⁿ Similarity(LM, PWi)/n is an average content similarity between the corresponding one of the plurality of learning materials and all n published works of the individual, and Init is a constant. Init may be set to 5 or some other constant to avoid returning an error when calculating the ACM involving an individual without a productivity measurement, e.g., any individual where P(pLM)=0. Accordingly, the academic credit measurement, in some embodiments, generally assigns greater value to learning materials by more productive individuals and/or that are more closely matched to the individuals' publications than to learning materials by less productive individuals and/or that are less closely matched to the individuals' publications.

Returning to FIG. 3, the social media credit measurement module 318 may be configured to calculate a social media credit measurement for each of the learning materials based on the extracted learning-specific features. The social media credit measurement module 318, in some embodiments, generally assigns greater value to learning materials by individuals who have a relatively large social media influence, whether or not the individuals are instructors or professors at an educational institution, than to learning materials by individuals with a relatively smaller social media influence.

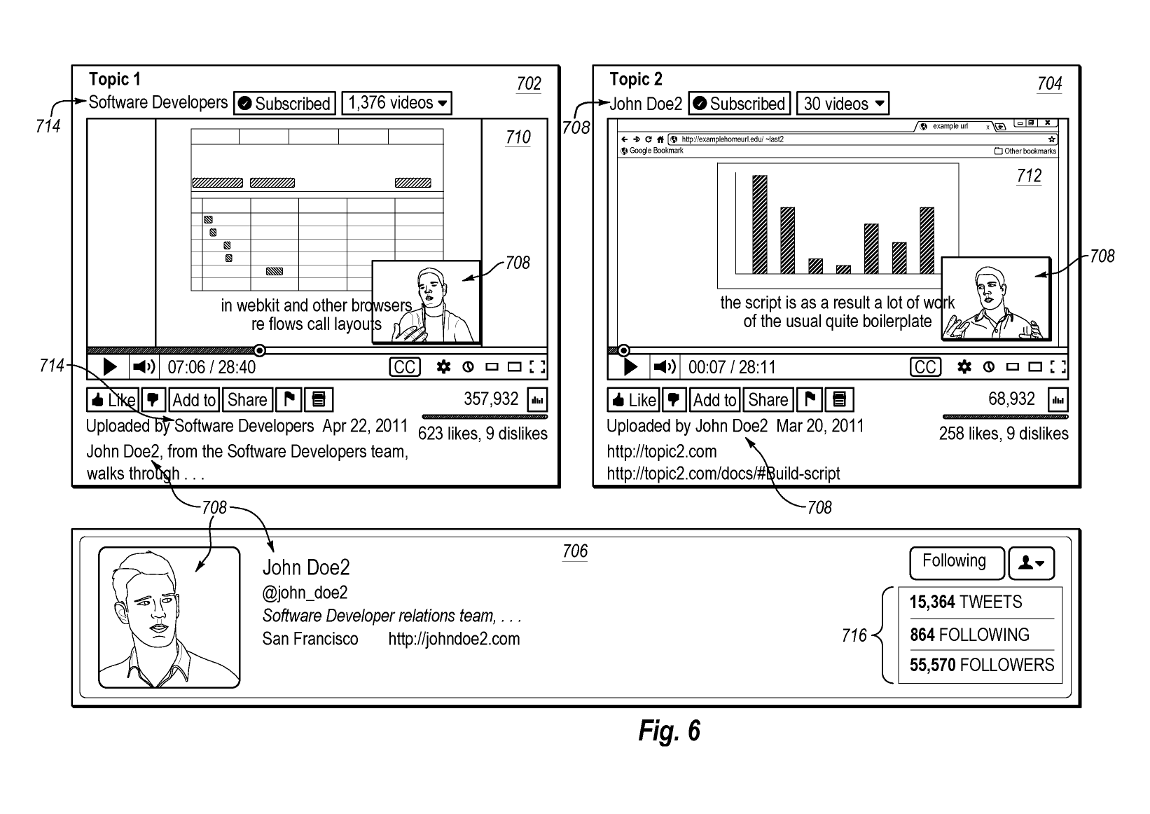

Consider FIG. 6, for example, which includes screen shots of web pages 702, 704, 706 associated with an individual 708, arranged in accordance with at least one embodiment described herein. The web pages 702, 704 each include a video 710, 712 or other learning material contributed by the individual 708, although the videos 710, 712 are not necessarily uploaded by the individual 708. For instance, the video 710 has been published to the Internet by an organization 714 with which the individual 708 is affiliated, e.g., as an employee or member of the organization 714 in this example, while the video 712 has been published to the Internet by the individual 708.

The web page 706 includes a portion of a TWITTER profile of the individual 708, including social connection information 716 indicating a social media influence of the individual 708. Some or all of the social connection information 716 may be used to calculate the social media credit measurement, or SMCM, for the videos 710, 712. Alternately or additionally, the social media credit measurement for the videos 710, 712 may depend on a topic-specific influence of the individual 708. In some embodiments, the social media credit measurement is calculated based on a TWITTER following graph or other TWITTER-related algorithm or metric. Examples of TWITTER-related algorithms or metrics may include, but are not limited to, TwitterRank, Topic-specific PageRank, Topic-specific TunkRank, or the like or any combination thereof. Descriptions of the foregoing are provided in: U.S. patent application Ser. No. 13/242,352; “TwitterRank: Finding Topic-sensitive Influential Twitterers” by J. Weng et al. (accessed on Dec. 28, 2012 at http://ink.library.smu.edu.sg/cgi/viewcontent.cgi?article=1503&context=sis_research); and “Overcoming Spammers in Twitter—A Tale of Five Algorithms” by D. Gayo-Avello et al. (accessed on Dec. 28, 2012 at http://di002.edv.uniovi.es/˜dani/downloads/CERI2010-camera-ready.pdf), all of which are incorporated herein by reference.

Returning to FIG. 3, the comprehensiveness measurement module 320 may be configured to calculate a comprehensiveness measurement for each of the learning materials based on the extracted learning-specific features. In many cases, learning materials are presented primarily in a single format, such as video, audio, text and/or graphical content (e.g., HTML, .pdf files, .doc or .docx files, .ppt or .pptx files, etc.). For instance, some lectures presented in a video format include primarily video content with perhaps some negligible amount of text content such as a brief description of what is covered in the lecture.

In other cases, learning materials in one format by some individuals have relatively well-matched counterpart learning materials in another format, which may provide a better and more comprehensive learning experience to users 108 when the learning materials in both formats are used together. For example, a professor or other individual may publish, for a given lecture, both a video recording of the lecture as well as lecture notes including text and/or graphical content. In these and other embodiments, the comprehensiveness measurement assigns a relatively greater value to learning materials with well-matched counterparts than to learning materials with poorly-matched counterparts or no counterparts at all.

As an example, consider FIGS. 4 and 5. The links 428 included in the learning materials page 406 of FIG. 4 may point to learning materials such as lecture notes including text and/or graphical content corresponding to certain lectures in a computer science course “CS229: Machine Learning.” Analogously, the links 510 of FIG. 5 may point to learning materials such as videos including video content corresponding to the same lectures in the computer science course “CS229: Machine Learning.” In this case, because both the lecture notes and the videos correspond to the same lectures, the lecture notes and the videos may receive greater comprehensiveness measurements than other learning materials that are not well-matched or not matched at all.

Returning to FIG. 3, in some embodiments, the comprehensiveness measurement, CM, may be calculated by the comprehensiveness measurement module 320 according to the following formula:

CM=Similarity(LM1,LM2)/2,

where LM1 is a first one of the learning materials 104 having a first format and LM2 is a second one of the learning materials 104 having a second format. In some embodiments, the comprehensiveness measurement calculated in this manner may be assigned to both the first one of the learning materials 104 and the second one of the learning materials 104.

With continued reference to FIG. 3, the ranking and recommendation engine 322 may be configured to rank each of the learning materials 104 based on both the content similarity measurement and one or more additional measurements such as the freshness measurement, the academic credit measurement, the social media credit measurement, and/or the comprehensiveness measurement. Ranking the learning materials may include, for each of the learning materials, calculating a rank, R, of the corresponding one of the plurality of learning materials according to the following formula:

R=α*CSM+β*FM+γ*ACM+δ*SCCM+ε*CM,

where α, β, γ, δ, and ε are weighting factors, and CSM, FM, ACM, SCCM, and CM are the measurements already described herein.

In an example embodiment, the weighting factors α, β, γ, δ, and δ are, respectively, 0.5, 0.1, 0.2, 01, and 0.1. Alternately, the weighting factors α, β, γ, δ, and ε may be initially specified as first values, e.g., at 0.5, 0.1, 0.2, 0.1, and 0.1, respectively, and may then be refined by machine learning for optimizing the calculated rank R.

With continued reference to FIG. 3, the user profile module 324 may be configured to generate user profiles for users that communicate with the system 106 to, e.g., submit queries to locate learning materials. The user profiles may include explicit user profiles, implicit user profiles, or any combination thereof.

Explicit user profiles may include keywords and other input explicitly provided by the users to build a user profile. Such keywords or other input may represent or correspond to topics of interest to the user, for example. In these and other embodiments, the user profile module 324 may guide each user through a process of building a profile, to the extent an explicit profile is desired.

Implicit user profiles may be auto-generated by tracking user activities, such as search activities, click activities, bookmark activities, or the like or any combination thereof. Contents involved in different activities may be assigned different weights. For example, contents from web pages that are bookmarked by a user may be assigned a higher weight than contents pointed to by links that are clicked by the user.

The explicit and/or implicit user profile for each user may be integrated into a text term vector that may be referred to as a user profile vector. When at least some terms in a learning material vector match at least some terms in the user profile vector, then the weight of the matching terms may be boosted in the content similarity measurement by the content similarity measurement module 310.

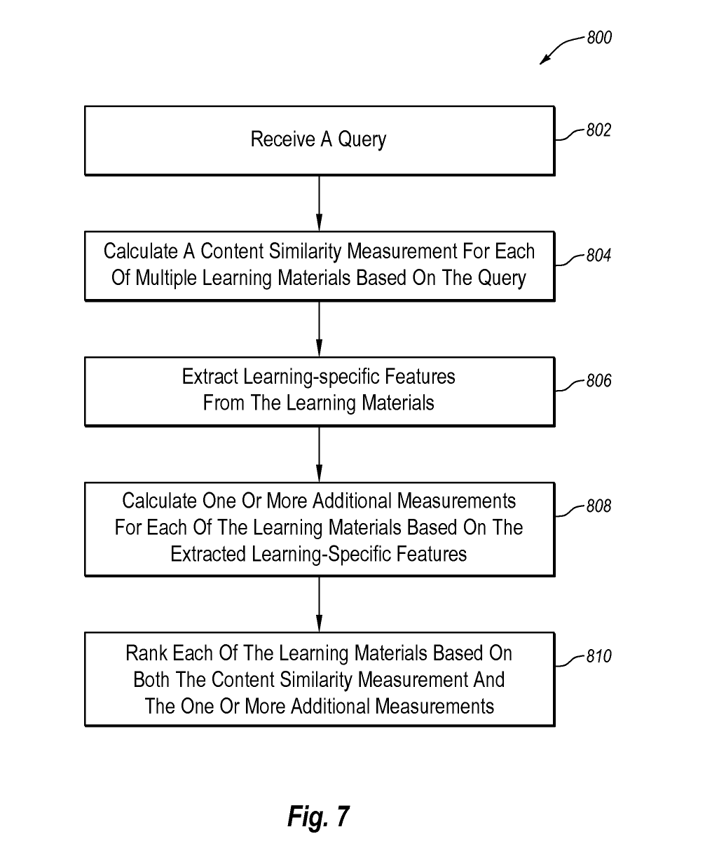

FIG. 7 shows an example flow diagram of a method 800 of automatically ranking and recommending open education materials, arranged in accordance with at least one embodiment described herein. The method 800 in some embodiments is performed by the system 106 of FIGS. 1 and 3, e.g., by the processor 302 executing the modules 326 in the memory 306. Although illustrated as discrete blocks, various blocks may be divided into additional blocks, combined into fewer blocks, or eliminated, depending on the desired implementation.

The method 800 may begin at block 802 in which a query is received. The query may be received from a user.

At block 804, a content similarity measurement may be calculated for each of multiple learning materials based on the query. In some embodiments, the calculation of the content similarity measurement is further based on a user profile of the user from which the query is received.

At block 806, learning-specific features may be extracted from the learning materials.

At block 808, one or more additional measurements may be calculated for each of the learning materials based on the extracted learning-specific features. In general, the one or more additional measurements may be different than the content similarity measurement. In some embodiments, the one or more additional measurements include first, second, third, and/or fourth measurements, or more particularly, the freshness measurement, the academic credit measurement, the social media credit measurement, and/or the comprehensiveness measurement.

At block 810, each of the learning materials may be ranked based on both the content similarity measurement and the one or more additional measurements. Ranking each of the learning materials may include calculating a rank of each of the learning materials.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include tangible computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method of automatically ranking and recommending open education materials, the method comprising:
receiving a query;
calculating a content similarity measurement for each of a plurality of learning materials based on the query;
extracting a plurality of learning-specific features from the plurality of learning materials;
calculating one or more additional measurements for each of the plurality of learning materials based on the extracted plurality of learning-specific features, the one or more additional measurements being different than the content similarity measurement; and
ranking each of the plurality of learning materials based on both the content similarity measurement and the one or more additional measurements.

2. The method of claim 1, wherein calculating the content similarity measurement is further based on a user profile of a user from which the query is received.

3. The method of claim 1, wherein the one or more additional measurements comprise, for each of the plurality of learning materials, at least one of:
a first measurement relating to an age of a corresponding one of the plurality of learning materials;
a second measurement relating to an academic impact of a corresponding one of the plurality of learning materials;
a third measurement relating to a social media impact of a corresponding one of the plurality of learning materials; or
a fourth measurement relating to a comprehensiveness of a corresponding one of the plurality of learning materials.

4. The method of claim 3, wherein the first measurement is calculated according to the formula FM=e^{(TY-CY/M)}, where FM is the first measurement, TY is a teaching year of the corresponding one of the plurality of learning materials, CY is a current year, and M is a constant such that 0<FM<1.

5. The method of claim 3, wherein the second measurement depends on both a productivity of an individual associated with a corresponding one of the plurality of learning materials and a match between the corresponding one of the plurality of learning materials and published works of the individual.

6. The method of claim 3, wherein the second measurement is calculated according to the formula:
ACM=Log(P(pLM)+Init)*Σᵢ₌₁ⁿSimilarity(LM,PWi)/n,
where ACM is the second measurement, LM is the corresponding one of the plurality of learning materials, pLM is the individual, P(pLM) is a productivity measurement of the individual, n is a total number of the published works of the individual, PWi with i ranging from 1 to n is all of the published works of the individual such that Σᵢ₌₁ⁿ Similarity(LM, PWi)/n is an average content similarity between the corresponding one of the plurality of learning materials and all n published works of the individual, and Init is a constant.

7. The method of claim 6, wherein P(pLM) comprises an H-index or a G-index of the individual.

8. The method of claim 3, wherein the third measurement depends on a topic-specific influence of an individual associated with a corresponding one of the plurality of learning materials on a social media platform.

9. The method of claim 3, wherein the fourth measurement is calculated according to the formula CM=Similarity (LM1, LM2)/2, where CM is the fourth measurement, LM1 is a first one of the plurality of learning materials having a first format, and LM2 is a second one of the plurality of learning materials having a second format different than the first format.

10. The method of claim 9, wherein the first portion LM1 includes a video of a lecture and the second portion LM2 includes lecture notes for the lecture.

11. The method of claim 3, wherein ranking each of the plurality of learning materials based on both the content similarity measurement and the one or more additional measurements comprises, for each of the plurality of learning materials, calculating a rank of the corresponding one of the plurality of learning materials according to the formula:
R=α*CSM+β*FM+γ*ACM+δ*SCCM+ε*CM,
where R is the rank, α, β, γ, δ, and ε are weighting factors, CSM is the content similarity measurement, FM is the first measurement, ACM is the second measurement, SCCM is the third measurement, and CM is the fourth measurement.

12. The method of claim 11, wherein α is 0.5, β is 0.1, γ is 0.2, δ is 0.1, and ε is 0.1.

13. A system for automatically ranking and recommending open education materials, the system comprising:
a processor;
a tangible computer-readable storage medium communicatively coupled to the processor and having computer-executable instructions stored thereon that are executable by the processor to perform operations comprising:
receiving a query;
calculating a content similarity measurement for each of a plurality of learning materials based on the query;
extracting a plurality of learning-specific features from the plurality of learning materials;
calculating one or more additional measurements for each of the plurality of learning materials based on the extracted plurality of learning-specific features, the one or more additional measurements being different than the content similarity measurement; and
ranking each of the plurality of learning materials based on both the content similarity measurement and the one or more additional measurements.

14. The system of claim 13, wherein calculating the content similarity measurement is further based on a user profile of a user from which the query is received.

15. The system of claim 13, wherein the one or more additional measurements comprise, for each of the plurality of learning materials, at least one of:
a first measurement relating to an age of a corresponding one of the plurality of learning materials;
a second measurement relating to an academic impact of a corresponding one of the plurality of learning materials;
a third measurement relating to a social media impact of a corresponding one of the plurality of learning materials; or
a fourth measurement relating to a comprehensiveness of a corresponding one of the plurality of learning materials.

16. The system of claim 15, wherein the first measurement is calculated according to the formula FM=e^{(TY-CY/M)}, where FM is the first measurement, TY is a teaching year of the corresponding one of the plurality of learning materials, CY is a current year, and M is a constant such that 0<FM<1.

17. The system of claim 15, wherein the second measurement is calculated according to the formula:
ACM=Log(P(pLM)+Init)*Σᵢ₌₁ⁿSimilarity(LM,PWi)/n,
where ACM is the second measurement, LM is a corresponding one of the plurality of learning materials, pLM is an individual associated with the corresponding one of the plurality of learning materials, P(pLM) is a productivity measurement of the individual, n is a total number of published works of the individual, PWi with i ranging from 1 to n is all of the published works of the individual such that Σᵢ₌₁ⁿ Similarity(LM, PWi)/n is an average content similarity between the corresponding one of the plurality of learning materials and all n published works of the individual, and Init is a constant.

18. The system of claim 15, wherein the third measurement depends on a topic-specific influence of an individual associated with a corresponding one of the plurality of learning materials on a social media platform.

19. The system of claim 15, wherein the fourth measurement is calculated according to the formula CM=Similarity (LM1, LM2)/2, where CM is the fourth measurement, LM1 is a first portion of a corresponding one of the plurality of learning materials having a first format, and LM2 is a second portion of the corresponding one of the plurality of learning materials having a second format different than the first format.

20. The system of claim 15, wherein ranking each of the plurality of learning materials based on both the content similarity measurement and the one or more additional measurements comprises, for each of the plurality of learning materials, calculating a rank of the corresponding one of the plurality of learning materials according to the formula:
R=αCSM+β*FM+γ*ACM+δ*SCCM+ε*CM,
where R is the rank, α, β, γ, δ, and δ are weighting factors, CSM is the content similarity measurement, FM is the first measurement, ACM is the second measurement, SCCM is the third measurement, and CM is the fourth measurement.
